(19) United States
(12) Patent Application Publication
(10) Pub. No.: US 2019/0001831 A1
(43) Pub. Date: Jan. 3, 2019

(54) METHOD FOR IMPLEMENTING POWER SUPPLY PROCEDURES FROM AT LEAST ONE POWER SUPPLY UNIT TO A PLURALITY OF TRANSPORTATION VEHICLES TO BE SUPPLIED WITH POWER

(71) Applicants: VOLKSWAGEN AG, Wolfsburg (DE); KUKA DEUTSCHLAND GMBH, Augsburg (DE)

(72) Inventors: Daniel SCHÜTZ, Lehre/Essenrode (DE); Michael GROTE, Gifhorn (DE); Jürgen STIEG, Isenbüttel (DE); Lutz JUNGE, Braunschweig (DE); Sven HORSTMANN, Berlin (DE); Thorsten BAGDONAT, Braunschweig (DE); Sebastian GRYSCZYK, Braunschweig (DE); Andreas WEISER, Braunschweig (DE); Norbert SETTELE, Petersdorf-Willprechtszell (DE)

(21) Appl. No.: 16/063,575

(22) PCT Filed: Dec. 19, 2016
(86) PCT No.: PCT/EP2016/081680

§ 371 Date: Jun. 18, 2018

(30) Foreign Application Priority Data
Dec. 18, 2015 (DE) 10 2015 225 986.2

(51) Int. Cl. B60L 11/18; B67D 7/04

(52) U.S. Cl. CPC B60L 11/1835; B67D 2007/0473; B60L 2230/10; B67D 7/0401

(57) ABSTRACT

A method for supplying power from at least one power supply unit to transportation vehicles requiring a power supply, in which a position of a transportation vehicle-side power supply interface of a transportation vehicle requiring power is determined for each vehicle and the transportation vehicle-side power supply interface is automatically coupled to a power supply interface of the power supply unit by the power supply interface of the power supply unit being moved by a robot to the transportation vehicle-side power supply interface and coupled thereto. A robot is responsible for coupling transportation vehicles to a suitable power supply interface of the power supply unit.

### PRIORITY CLAIM

This patent application is a U.S. National Phase of International Patent Application No. PCT/EP2016/081680, filed 19 Dec. 2016, which claims priority to German Patent Application No. 10 2015 225 986.2, filed 18 Dec. 2015, the disclosures of which are incorporated herein by reference in their entireties.

### SUMMARY

Illustrative embodiments relate to a method for implementing power supply procedures from at least one power supply unit to a plurality of transportation vehicles to be supplied with power.

Illustrative embodiments further relate to a power supply unit and a transportation vehicle for implementing the method.

### BRIEF DESCRIPTION OF THE DRAWINGS

In the figures, schematically in each case:

FIG. 1 shows a first embodiment of a power supply unit, in a bird's eye overhead view;

FIG. 2 shows a second embodiment of a power supply unit, in a bird's eye overhead view;

FIG. 3 shows a detailed representation of a transportation vehicle-side power supply interface, viewed at III in FIG. 2;

FIG. 4 shows a view of the power supply interface, viewed at IV in FIG. 3;

FIG. 5 shows a representation of a projection pattern which is projectable by a laser onto a special projection surface;

FIG. 6 shows a third embodiment of a power supply unit, in a bird's eye overhead view; and

FIG. 7 shows a flow diagram for the clarification of a potential process sequence.

### DETAILED DESCRIPTION

From document WO 2013/041133 A1 a method and a power supply unit are known.

Specifically, WO 2013/041133 A1 discloses a power supply unit (charging unit) which can be moved on a rail, which can travel to a plurality of parking spaces in a parking area, and can supply parked electric transportation vehicles with electric power.

The moveable charging unit is equipped with an image detection device as a camera, which is employed for the detection of a positon of a power supply interface (charging interface) on a transportation vehicle which is to be charged. In the interests of the simplification of image recognition, it is proposed that the charging interface be equipped with appropriate visual features including, for example, lamps, markings or reflectors. It is proposed here that a charging cable of the charging unit can be paid-out from the charging unit by a robot arm (extendable rod). Once a respective parking space has been approached, the charging cable is paid-out, and the associated charging plug is plugged into the charging interface of the transportation vehicle which is to be charged. To synchronize the charging process between an electric transportation vehicle to be charged and the charging unit, at least one confirmation of the charging process by the transportation vehicle driver is required. Accordingly, communication between the transportation vehicle and the charging unit by a communication device, for example, via a WLAN port, is enabled. It is further proposed that either a plurality of charging units be employed, to permit the parallel operation of the charging units, or that access to a charging unit or to an appropriate robot for this purpose be permitted on a plurality of charging cables, to sequentially execute power supply procedures.

From DE 10 2009 006 982 A1, a power supply unit is known which is equipped with a multi-articulated robot arm, which is employed for the positioning and connection of a charging plug to a charging socket of a transportation vehicle to be charged. The power supply unit additionally incorporates a detection unit for the positional detection of the charging socket on the transportation vehicle. The detection unit detects the position of the charging socket on the transportation vehicle on the basis of optical or geometrical characteristics of the charging socket.

A communication device is further arranged on the power supply unit, which is configured for the reception of information on the transportation vehicle and of a charge controller. The function of the charge controller is the initiation or interruption of a charging process, according to the state of charge of the transportation vehicle.

It is also proposed that the detection unit for the detection of the position of the charging socket be configured on the basis of an RFID chip (RFID=radio frequency identification).

Finally, DE 10 2012 216 980 A1 describes a robotic charging station for the charging of a battery of an electric transportation vehicle. Herein, the robot is fitted, in a moveable arrangement, to an elevation rod, which is coupled to a base plate.

The robot incorporates a gripper element with an electric plug, which is designed for coupling with a transportation vehicle-side charging socket.

For the presence detection of a transportation vehicle to be charged, the base plate incorporates a sensor, which employs optical, acoustic or also RFID-based detection methods or mechanisms.

In the vicinity of the plug, the robot arm further incorporates a camera for the detection of the position of a transportation vehicle-side charging socket, thus permitting the accurate movement of the gripper element of the robot in relation to the transportation vehicle-side charging socket. It is also proposed that a plurality of cameras be employed, to be able to provide a stereoscopic view of the transportation vehicle and/or of the charging socket thereof.

Specifically, according to the constituent prior art of the preamble of the present claims 1 and 5, the execution of a plurality of power supply procedures either requires a great complexity of hardware (multiple charging units), or the time required for the identification of a transportation vehicle-side power supply interface is incompatible with the temporal streamlining of a plurality of power supply procedures.

In consideration of the above-mentioned prior art, the disclosed embodiments provide of a method for implementing power supply procedures from at least one power supply unit to a plurality of transportation vehicles to be supplied with power, the efficiency of which can be improved.

Disclosed embodiments provide an appropriate transportation vehicle and an appropriate power supply unit for the implementation of the method.

Disclosed embodiments provide a method for implementing power supply procedures between at least one power supply unit and a plurality of transportation vehicles to be supplied with power. To this end, a position of a transportation vehicle-side power supply interface on a transportation vehicle to be supplied is determined in each case. Automatic coupling between a transportation vehicle-side power supply interface and a power supply interface on the power supply unit proceeds in each case, in that the power supply interface of the power supply unit is moved by a robot to the transportation vehicle-side power supply interface, and is coupled to the latter. The robot is required to execute the coupling of a plurality of transportation vehicles having an appropriate power supply interface to the power supply unit. It is thus suitable at least for the coupling of two transportation vehicles having an appropriate power supply interface.

It is thus proposed that, by the power supply unit, the position of a transportation vehicle-side power supply interface on such a transportation vehicle is determined, which is associated with a specific power supply interface on the power supply unit. This positional identification then proceeds, even when the robot is not available for the purposes of movement and coupling to the power supply interface which is assigned to the transportation vehicle on the power supply unit.

In this manner, a basis can be established for a significant increase in efficiency in the preparation and execution of power supply procedures.

Thus, for example, in the case of a second transportation vehicle to be supplied with power, the position of the power supply interface thereof relative to the power supply unit can be determined while the robot is still engaged in the coupling of the power supply interface of a first transportation vehicle to a power supply interface which is assigned to the first transportation vehicle on the power supply unit. Upon the commencement of the power supply procedure for the second transportation vehicle, a preliminary determination of the position of the transportation vehicle-side power supply interface is thus no longer necessary, thereby resulting in a corresponding time saving. The robot is already aware of the positional data, and can employ these directly.

It is expressly indicated that the term “power” not only includes electrical energy, such as electric current, but also chemical energy, such as liquid or gaseous fuels (e.g., gasoline, diesel, gas, hydrogen).

The term “power supply unit” is also to be understood correspondingly, and can be configured, for example, as a charging station for electric current, a filling pump for fuel, or similar. A combination of such configurations, in the context of hybrid transportation vehicles, is entirely conceivable.

Additionally, the robot can be structurally integrated as a structural element into the power supply unit, but is not necessarily configured as such. The robot can also be configured as a separately actuable moving device for the power supply interface of the power supply unit. Moreover, the term “robot” can be understood as any device which is appropriate for the movement of a power supply interface of the power supply unit, and for the coupling thereof with a power supply interface on a transportation vehicle. In a practical configuration, a robot can therefore be understood to comprise a simple actuator, or a more complex industrial robot having a plurality of degrees of freedom.

According to a first disclosed embodiment, the position of a transportation vehicle-side power supply interface is in each case identified by at least one image detection device which is spatially separated from the robot. This device may be arranged in the vicinity of a parking space of a transportation vehicle to be supplied. For example, an image detection device of this type can be arranged on a top cover or a wall of the power supply unit.

This contributes to the reliability of the method, specifically where, by one robot, a plurality of power supply interfaces of a power supply unit are to be moved and coupled to transportation vehicles.

In this connection, it is indicated that, for the execution of the disclosed method or for the positional determination of a transportation vehicle-side power supply interface, the employment of a wide variety of measuring systems is conceivable.

Thus, for example, the employment of a type of sensor bar is conceivable, in which a depth sensor, a webcam, a 3D microphone and an acceleration sensor are mutually combined. By this arrangement, characteristic geometrical points on the power supply unit can measured with a high degree of spatial accuracy.

By the use of laser scanners, markings or geometrical shapes on the power supply unit can be accurately and cost-effectively detected using the known method of triangulation.

Photonic mixer devices (PMD cameras) operate by the principle of the pulsed light method, wherein measured objects are illuminated by light pulses, and the signal transit time is measured. The distance between the camera and the object can be determined on the basis of the transit time.

For the spatial measurement (photogrammetry) of geometrical shapes on the power supply unit, the use of a plurality, or at least two, cameras arranged in close mutual proximity is conceivable.

According to a further disclosed embodiment, it is proposed that the position of a vehicle-side power supply interface is respectively determined by the evaluation of a projection pattern, which is projected by the transportation vehicle to be supplied onto such a measuring target of the power supply unit, which is associated with the transportation vehicle to be supplied.

The reliability of the method can also be increased accordingly. For example, it is conceivable that the projection pattern is a pattern of intersecting lines, which is projected by a transportation vehicle-side laser onto the measuring target. In this case, the cost-effective employment of conventional proprietary cross-line lasers is entirely conceivable.

A projection pattern of this type can easily be detected by an image detection device. Such a pattern may be generated by a laser. For example, the size and position of the projection pattern can be evaluated relative to measuring points on the measuring target, and the position of the laser can be concluded accordingly.

As soon as the position of the laser has been identified, the position of a reference point for the transportation vehicle-side power supply interface can also be concluded by the known methods of coordinate transformation, because the relative position of the transportation vehicle-side power supply interface, relative to the laser, is known.

In the light of any potential damage or vandalism, it is highly appropriate that any such power supply procedure should be video-monitored.

As mentioned above, the disclosed embodiments further relates to a power supply unit for implementing the disclosed method. The unit incorporates at least one moveable power supply interface. The latter is moveable by a robot, and can be coupled to a power supply interface on a transportation vehicle which is to be supplied with power. The function of the robot is the movement and coupling of the at least one power supply interface of the power supply unit to at least two transportation vehicles.

The power supply unit is characterized in that at least two parking spaces are provided for the supply of power to at least two transportation vehicles. At least one image detection device of the power supply unit is assigned to each parking space, wherein the function of the at least one image detection device is the determination of the position of such a power supply interface on a transportation vehicle, which is to be coupled to a power supply interface on the power supply unit which is assigned thereto. In this case the determined position of such a transportation vehicle-side power supply interface can be made available to the robot. This can take place by a wired or a wireless arrangement.

To permit the more effective monitoring of each power supply procedure, at least one video recording device can be assigned to each parking space of the power supply unit. By this arrangement, for example, monitoring periods of several days can be executed.

In a further configuration of the power supply unit, at least one measuring target is assigned to each parking space of the power supply unit, onto which a geometrical pattern is projectable, wherein the at least one image detection device of a parking space assumes an alignment with the measuring target.

In a configuration of this type, the power supply unit can be employed for the execution of an embodiment of the disclosed method.

Finally, the disclosed embodiments also relate to a transportation vehicle for the implementation of the disclosed method. The transportation vehicle is characterized in that, on the latter, at least one laser is arranged in the vicinity of a power supply interface, the light of which is emittable in the direction of a perpendicular plane of the power supply interface. By this arrangement, a fundamental precondition for the execution of an embodiment of the disclosed method.

The transportation vehicle can be further developed in that, by the light that can be emitted from the laser onto a projection surface, a projection pattern as at least two intersecting lines can be generated.

In this manner, an easily detectable and evaluable projection pattern can be provided. The employment of a conventional proprietary cross-line laser is moreover possible.

Exemplary embodiments are represented in the figures, and are described in greater detail hereinafter, with reference to the figures. Herein, the same reference symbols refer to identical, comparable or functionally equivalent components, wherein corresponding or comparable properties and benefits are achieved, even where any repeated description thereof is omitted.

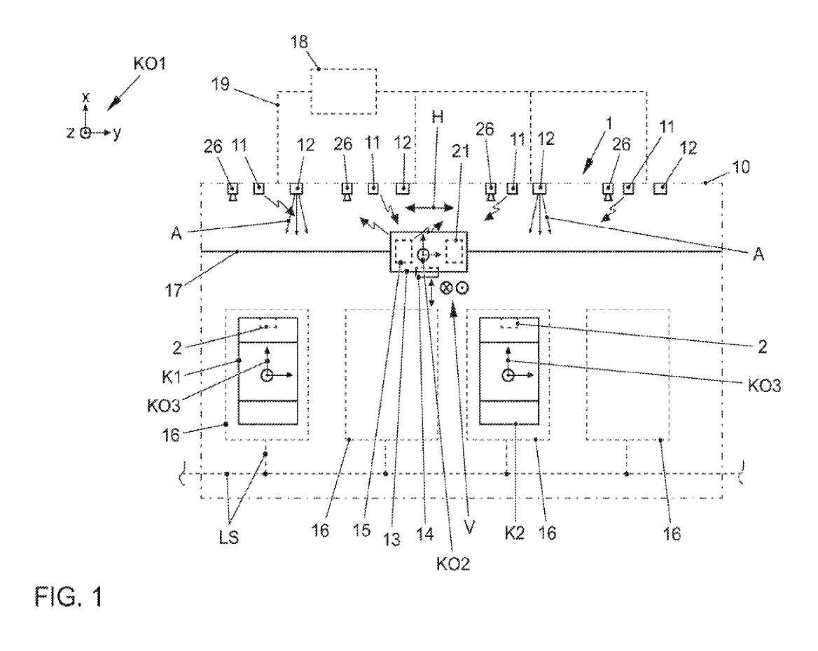

In FIG. 1, a power supply unit 1 can be seen. Specifically, the power supply unit 1 is configured as a parking area which is accessible to electric transportation vehicles, for the purposes of the electrical charging of the electric transportation vehicles.

Ahead of the power supply unit 1, four parking space markings 16 can be seen, within which transportation vehicles to be charged can be parked.

In the present exemplary embodiment, transportation vehicles to be charged, by an inductive guide system LS, can be automatically parked within the parking spaces markings 16, and released for charging.

The power supply unit 1 incorporates a robot 13, which can be moved on a rail 17 in a horizontal direction H, and can thus be positioned in front of each of the parking space markings 16.

The robot 13 further incorporates a power supply interface 14 as a charging plug. The charging plug 14 can be moved, by a mechanism which is not represented in greater detail, in the direction of a transportation vehicle which is to be charged (c.f. the double-headed arrow). The mechanism also delivers a vertical movement V of the charging plug 14.

A wireless transmission device 15 as a WLAN port and a control device 21 for the control of the movement of the robot 13 are installed in the robot 13.

Conversely, on the side of the power supply unit 1, each parking space marking 16, i.e., each parking space, is associated with a wireless transmission device 11 (WLAN port), an image detection device 12 (camera) and a video camera 26. These units are respectively mounted on a top cover 10 of the power supply unit 1, and are connected via signal lines 19 to a storage, computing and processing unit 18 in a signaling circuit arrangement. Alternatively to the exemplary embodiment, the image detection device 12 can also be a moving part of the power supply unit 1, i.e., not configured in a stationary arrangement.

K1 and K2 represent transportation vehicles to be electrically charged, each of which has been parked within a parking space marking 16, and are thus to be considered as assigned to the charging plug 14 for charging. Each of the transportation vehicles K1, K2 incorporates a power supply interface 2 as a charging socket.

KO1 represents a coordinate system of the power supply unit 1, KO2 represents a coordinate system of the robot 13, and KO3 represents a coordinate system of the transportation vehicle K1 or the transportation vehicle K2.

If positional coordinates for a relevant point within one of these coordinate systems are known, the storage, computing and processing unit 18 can also draw a conclusion as to the relative position of such a point relative to each of the other coordinate systems by the application of known methods of the coordinate transformation. If, for example, in coordinate system KO1, the positional coordinates of the charging socket 2 of one of the transportation vehicles K1, K2 are known, the position thereof can also be concluded by the robot 13 in coordinate system KO2. The robot 13 is thus able to move the charging plug 14 exactly to the charging socket 2.

Alternatively to the exemplary embodiment, fewer or more parking space markings 16 are also conceivable, but no fewer than two. It is also possible that a plurality of robots 13 are provided, to which respectively at least two parking space markings 16 are assigned. Accordingly, the function of each robot is invariably the supply of a plurality of transportation vehicles, but no fewer than two.

A plurality of power supply procedures executed by the power supply unit 1 can now proceed as follows:

Firstly, the transportation vehicle K1 is parked within a parking space marking 16. The position of the charging socket 2 thereof is detected here by the camera 12 which is assigned to the parking space marking 16. The camera 12 assumes an orientation A, which is oriented toward the transportation vehicle K1. In place of one camera, the employment of a plurality of cameras for positional detection is also conceivable. Accuracy can be improved accordingly. The use of distinctive markings or geometrical shapes in the region of the charging socket 2 is also recommended, to improve the detectability of the charging socket 2 by the camera 12.

The image data recorded are compared with reference data and evaluated in the storage, computing and evaluation unit 18. Positional coordinates for the charging socket 2 are calculated, and are transmitted via the transmission device 11 to the transmission device 15 of the robot 13. The transmission device 15 passes on the positional coordinates to the control device 21. These are initially stored therein.

Thereafter, the robot 13 travels to the front of the transportation vehicle K1, and moves its charging plug 14 toward the charging socket 2, in accordance with the known positional coordinates thereof.

While the robot 13 is involved in the coupling of its charging plug 14 to the charging socket 2 of the transportation vehicle K1, a second transportation vehicle K2 is parked within a parking space marking 16. Immediately, by a camera 12 which is assigned to the parking space marking 16 or to the transportation vehicle K2, the position of the charging socket 2 of the transportation vehicle K2 is determined in turn, and is made available to the robot 13. This proceeds in an analogous manner to that described above, even though the robot 13 is not yet available for the movement and coupling of its charging plug 14 to the charging socket 2 of the transportation vehicle K2.

However, as soon as the robot 13 has completed the charging of the transportation vehicle K1, it uncouples its charging plug 14 from the charging socket 2 of the transportation vehicle K1. The transportation vehicle K1 can then again be driven away automatically. After the uncoupling of the charging plug 14, the robot 13 can immediately move the latter (with no time delay) to the charging socket 2 of the transportation vehicle K2 and proceed with the coupling thereof to the latter, as the positon of the charging socket 2 of the transportation vehicle K2 is already known.

The method proceeds correspondingly, where further transportation vehicles are parked within one of the parking space markings 16.

By the video cameras 26, the respective power supply procedures, and the intervening time intervals, can be monitored on a continuous basis.

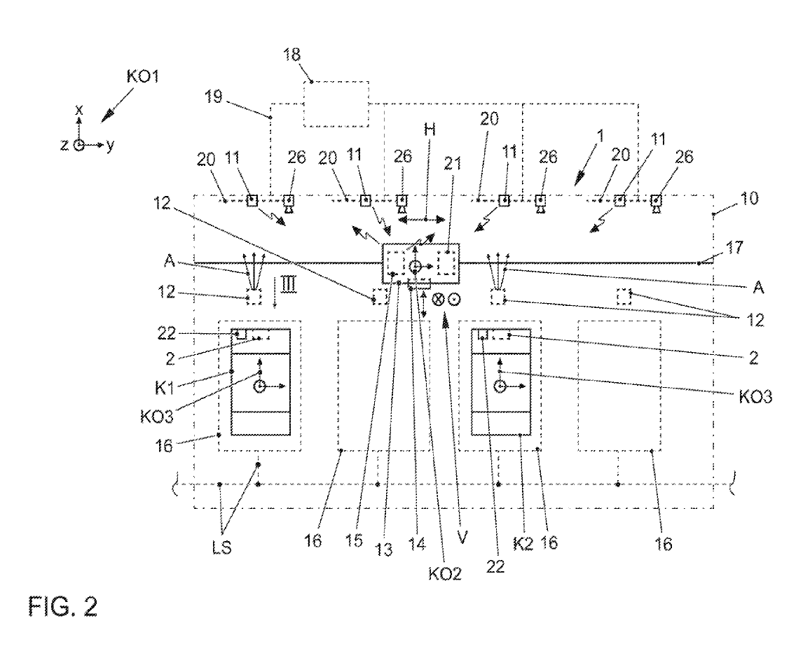

FIG. 2 represents a power supply unit 1 in which, in a distinction from the preceding embodiment, a measuring target 20 is respectively assigned to each parking space marking 16, and thus to each transportation vehicle to be supplied.

In the present disclosed embodiment, moreover, the orientation A of each camera 12 is aligned with the respective measuring target 20. Additionally, each transportation vehicle K1, K2 to be supplied is equipped with a laser 22 as a conventional proprietary cross-line laser.

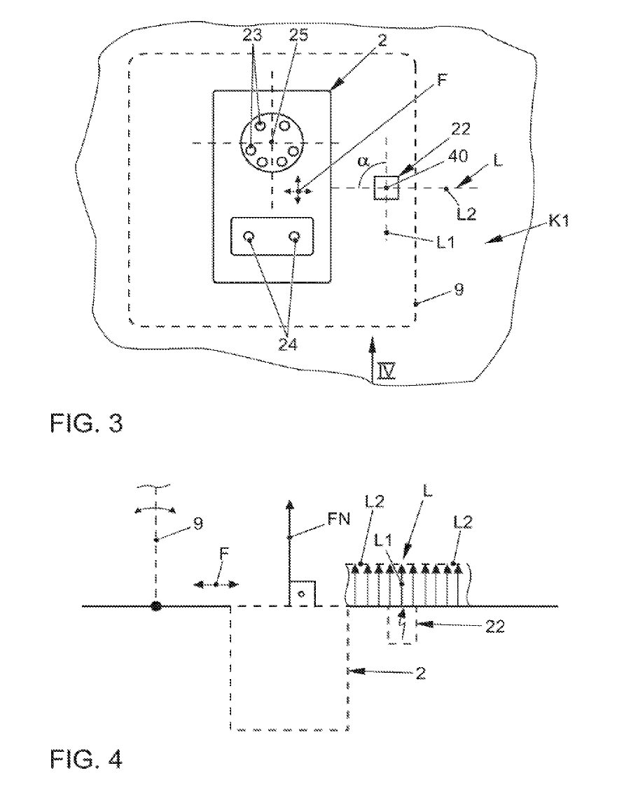

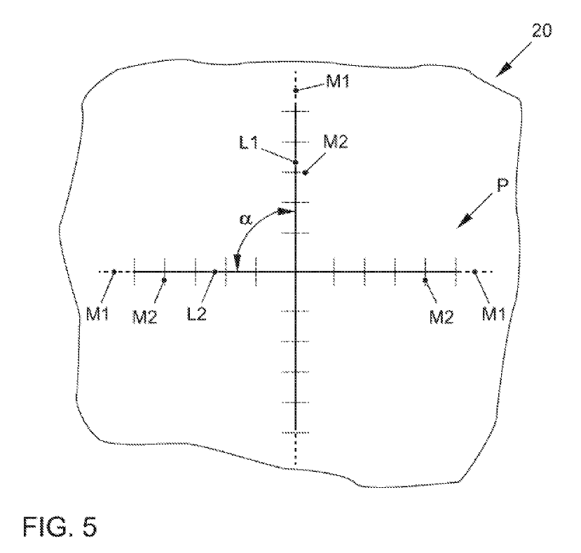

If a transportation vehicle K1, K2 to be supplied is parked within a parking space marking 16, the laser 22 is also activated, and emits light beams L (c.f. FIGS. 3 and 4) which are oriented toward the measuring target 20. Accordingly, a projection pattern P (c.f. FIG. 5) is generated on the measuring target 20, which is easily detectable by the camera 12 and can be easily evaluated by the storage, computing and processing unit 18.

From the position and spread of the projection pattern P on the measuring target 20, it is possible to conclude the positional coordinates of the laser 22. By the application of known coordinate transformation methods, the position of the charging socket 2 can be calculated. Here again, positional detection of the transportation vehicle-side charging socket 2 is respectively executed by the power supply unit 1, or by the components thereof, and is made available to the robot 13 via the transmission units 11. Again, this occurs even where the robot 13 is not available for the movement and coupling of the charging plug 14 to that charging socket 2 of which the position has been calculated beforehand.

FIGS. 3 and 4 represent the immediate environment of the charging socket 2. The charging socket 2 incorporates electrical contacts 23 for an AC terminal and electrical contacts 24 for a DC terminal. 25 represents a central reference point which can be, for example, a ground contact of the charging socket 2. The charging socket 2 has a surface extent F and, together with the laser 22, can be covered by a pivoting cover 9.

It will be seen that the above-mentioned laser 22 is arranged in the immediate vicinity of the actual charging socket 2. The laser 22 has a mid-point 40, and is able to emit light beams L as intersecting lines of radiation L1 and L2. Specifically, the laser 22 emits light beams L in the direction of or parallel to a surface normal FN to the surface extent F, which intersect at an angle α of 90 degrees.

A measuring target 20 is represented in detail in FIG. 5. It will be seen that, by the light beams L directed onto the measuring target 20 by the laser 22, a projection pattern P is generated, comprised of lines of radiation L1 and L2 which intersect at an angle α of 90°.

The measuring target 20 is further provided with graduations M1 and M2 wherein, from the relative position of the projection pattern P in relation to the graduations M1, M2, the position of the laser 22 relative to the measuring target 20 and, ultimately, by the application of known methods for coordinate transformation, also the relative position of the charging socket 2 to the robot 13 can be concluded.

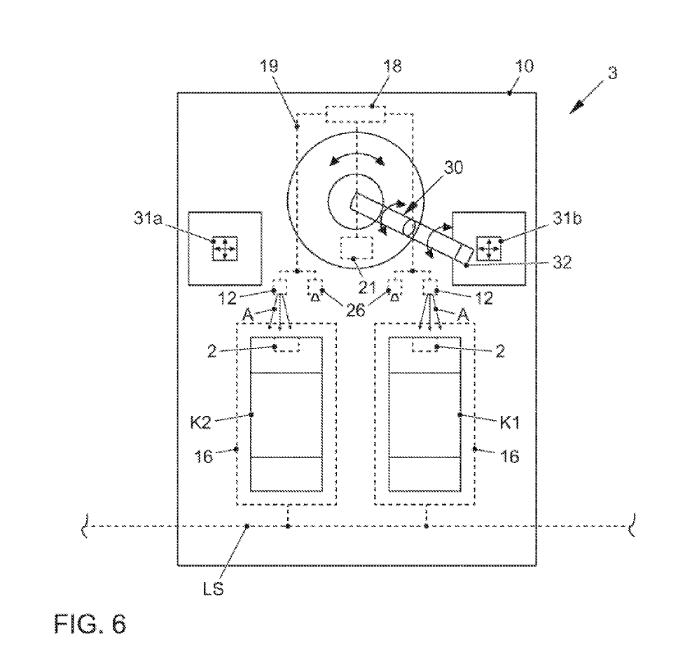

FIG. 6 represents a further exemplary embodiment as a power supply unit 3. In the power supply unit 3, a robot 30 is employed, which is configured as an “industrial robot” having a plurality of degrees of freedom (c.f. the double-headed arrow).

The robot 30 is required to assume the respective coupling of a maximum of two transportation vehicles K1, K2, which are parked within the parking space markings 16 of the power supply unit 3 by the inductive guide system LS, to a power supply interface 31b or 31a of the power supply unit 3 as a charging plug.

Each charging plug 31a, 31b is moveable (c.f. the arrows) and, by a gripper device 32 on the robot 30, can be moved toward a charging socket 2 of a parked transportation vehicle K1 or K2 assigned to the charging plug 31b or 31a and be coupled to the latter. Here again, a camera 12 is assigned to each parking space marking 16, having an orientation A to the parking space marking 16. The camera 12 can be a stationary or a moveable component of the power supply unit 3. It can be connected, for example, to a top cover 10. A video camera 26 is again employed for the monitoring of all procedures in the region of the parking space markings 16.

By the cameras 12, a positon of a charging socket 2 can be detected. The cameras 12 and 26 and the control device 21 of the robot 30 are connected by signal lines 19 to a storage, computing and evaluation unit 18, in a signaling circuit arrangement. Positional data for each charging socket 2 can thus be determined and, immediately thereafter or subsequently, made available to the control device 21. Here again, positional detection proceeds independently of the availability of the robot 30, as a result of which, in an analogous manner to the previously described power supply units, significant improvements in efficiency can be achieved.

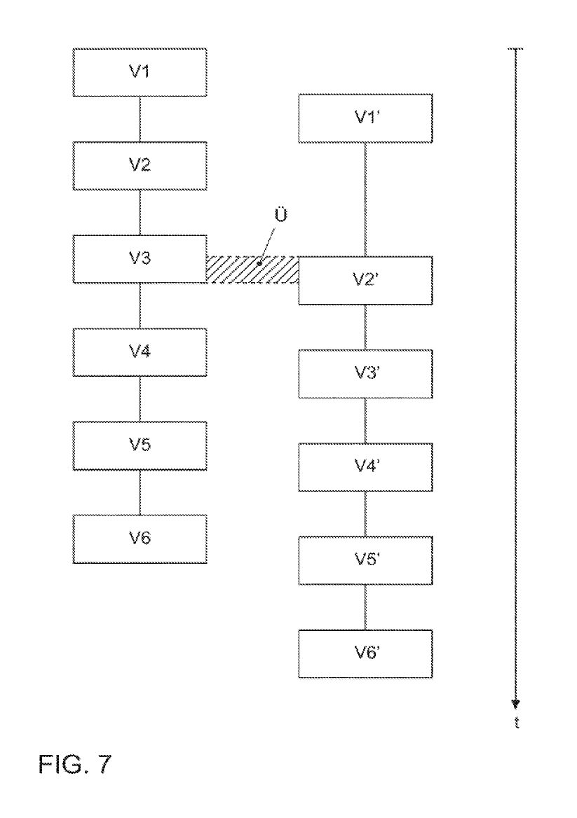

Finally, with reference to FIG. 7, the disclosed method will again be described in brief, with reference to the final exemplary embodiment represented.

A timeline representing a time t is indicated, to clarify the temporal relationship between the process operations.

Thus, firstly, the automatic parking of the transportation vehicle K1 within the parking space marking 16 is executed, with a tolerance margin of 5 cm (process operation at V1) optionally. Thereafter, by the camera 12, positional data for the charging socket 2 of the transportation vehicle K1 are determined, and are made available to the robot 30 (process operation at V2).

In a parallel and, where applicable, time-deferred sequence, the second transportation vehicle K2 is parked automatically in a process operation at V1′. In the interim, the movement by the robot 30 of the charging plug 31b which is assigned to the transportation vehicle K1 toward the charging socket 2 of the transportation vehicle K1 has commenced, to execute the coupling (process operation at V3). Thus, during this time, the robot 30 is not available for the movement of the charging plug 31a.

Even before the robot 30 is available for the movement of the charging plug 31a (c.f. the overlap region Ü), the charging socket 2 of the transportation vehicle K2 is surveyed by the camera 12 which is assigned to the transportation vehicle K2, and the position thereof is determined (process operation at V2′). This is associated with significant time benefits. The positional data determined can be made available to the robot 30, either immediately thereafter or at a subsequent time point.

In the interim, further to successful coupling, the charging of the transportation vehicle K1 will proceed (process operation at V4). The gripper device 32 of the robot 30, further to the completion of the coupling of the charging plug 31b to the charging socket 2 of the transportation vehicle K1, was temporarily released from the charging plug 31 again, and is thus available for the movement and the coupling of the charging plug 31a which is assigned to the transportation vehicle K2.

If positional data for the charging socket 2 of the transportation vehicle K2 have not already been transmitted to the robot 30, the data are now made available to the robot 30, which is possible with no significant time delay.

By the robot 30, the coupling of the charging plug 31a to the charging socket 2 of the transportation vehicle K2 can then proceed (process operation at V3′), and the charging of the transportation vehicle K2 can commence (process operation at V4′). Further to the completion of coupling, the robot 30 is therefore immediately available for the movement of the charging plug 31b again.

In the interim, the charging of the transportation vehicle K1 has been completed. The charging plug 31b could therefore be removed again from the charging socket 2 of the transportation vehicle K1 by the robot 30, and returned to its starting position (process operation at V5).

Further to this uncoupling, the transportation vehicle K1 can be driven away again (process operation at V6), and the parking space marking 16 is then available for a further transportation vehicle.

These process operations proceed analogously for the transportation vehicle K2, i.e., with the uncoupling of the charging plug 31a (process operation at V5′) further to the completion of charging (V4′) and driving away (process operation at V6′).

### LIST OF REFERENCE SYMBOLS

1 Power supply unit
2 Transportation vehicle-side power supply interface; charging socket
3 Power supply unit
9 Cover
10 Top cover
11 Transmission device (WLAN port)
12 Image detection device; camera
13 Robot
14 Power supply interface of the power supply unit; charging plug
15 Transmission device (WLAN port)
16 Parking space markings
17 Rail
18 Storage, computing and evaluation unit
19 Signal lines
20 Measuring target
21 Control device
22 Laser; cross-line laser
23, 24 Electrical contacts
25 Reference point for charging socket
26 Video camera
30 Robot
31a, b Power supply interface of the power supply unit; charging plug
32 Gripper device
40 Mid-point of the laser
A Orientation of the camera
F Surface extent of the transportation vehicle-side power supply interface or laser
FN Surface normal to the surface extent
H Horizontal movement
K1 Transportation vehicle
K2 Transportation vehicle
KO1 Coordinate system of the power supply unit
KO2 Coordinate system of the robot
KO3 Coordinate system of the transportation vehicle
L Light beams
L1 Line of radiation
L2 Line of radiation
LS Inductive guide system
M1, M2 Graduations
P Projection pattern of light beams
t Time
Ü Overlap region
V Vertical movement
V1-V6, V1′-V6′ Process operations

1. A method for implementing power supply procedures between at least one power supply unit and a plurality of transportation vehicles to be supplied with power, the method comprising:
determining a position of a transportation vehicle-side power supply interface on a transportation vehicle to be supplied; and
automatic coupling between the transportation vehicle-side power supply interface and a power supply interface on the power supply unit so the power supply interface of the power supply unit is moved by a robot to the transportation vehicle-side power supply interface, and is coupled to the transportation vehicle-side power supply interface,
wherein the robot executes the coupling of a plurality of transportation vehicles having an appropriate power supply interface to the power supply unit,
wherein, by of the power supply unit, the position of a transportation vehicle-side power supply interface on such a transportation vehicle is determined, which is associated with a specific power supply interface on the power supply unit, and
wherein positional identification then proceeds, even when the robot is not available for the purposes of movement and coupling to the power supply interface which is assigned to the transportation vehicle on the power supply unit.

2. The method of claim 1, wherein the position of a transportation vehicle-side power supply interface is identified by at least one image detection device spatially separated from the robot.

3. The method of claim 1, wherein the position of a transportation vehicle-side power supply interface is respectively determined by the evaluation of a projection pattern, which is projected by the transportation vehicle to be supplied onto such a measuring target of the power supply unit, which is associated with the transportation vehicle to be supplied.

4. The method of claim 1, wherein any power supply procedure is video-monitored.

5. A power supply unit for implementing a method for implementing power supply procedures between at least one power supply unit and a plurality of transportation vehicles to be supplied with power, having at least one moveable power supply interface is respectively coupled to a power supply interface of a transportation vehicle which is supplied with power, and has at least one robot, which which couples a power supply interface of the power supply unit to at least two transportation vehicles, wherein at least two parking spaces are provided for the supply of power to at least two transportation vehicles, and at least one image detection device of the power supply unit is assigned to each parking space, wherein the function of the at least one image detection device is the determination of the position of such a power supply interface on a transportation vehicle, which is coupled to a power supply interface on the power supply unit assigned thereto, wherein the position of such a transportation vehicle-side power supply interface determined is made available to the robot.

6. The power supply unit of claim 5, wherein at least one video recording device is assigned to each parking space of the power supply unit.

7. The power supply unit of claim 5, wherein at least one measuring target is assigned to each parking space of the power supply unit, onto which a geometrical pattern is projectable, wherein the at least one image detection device of the parking space assumes an alignment with the measuring target.

8. A transportation vehicle for implementing a method for implementing power supply procedures between at least one power supply unit and the transportation vehicle of claim 1, wherein, at least one laser is arranged in the vicinity of a power supply interface, the light of which is emittable in the direction of a perpendicular plane of the power supply interface.

9. The transportation vehicle of claim 8, wherein, by the light that is emitted from the laser onto a projection surface, a projection pattern of at least two intersecting lines is generated.
